(19) United States
(12) Patent Application Publication
(10) Pub. No.: US 2014/0324216 A1
(43) Pub. Date: Oct. 30, 2014

(54) METHOD, SYSTEM AND APPARATUS FOR MANAGING MEDICATION DELIVERY

(71) Applicants: Sami A Beg, Greenville, NC (US); Sumyra Kachru, Greenville, NC (US); M Ashraf Beg, Kashmir (IN)

(72) Inventors: Sami A Beg, Greenville, NC (US); Sumyra Kachru, Greenville, NC (US); M Ashraf Beg, Kashmir (IN)

(21) Appl. No.: 14/164,093

(22) Filed: Jan. 24, 2014

Related U.S. Application Data
(60) Provisional application No. 61/756,352, filed on Jan. 24, 2013.

(51) Int. Cl. G07F 7/08; G07F 9/00

(52) U.S. Cl. CPC G07F 7/08; G07F 9/006
USPC 700/232

(57) ABSTRACT

Method, system, and apparatus are disclosed for managing medication delivery. The method includes registering a plurality of patients with a system, associating a registered patient with personal biometric data, recording a plurality of patient tasks for subsequent recognition of task-events, associating the registered patient with an identifiable medical device, performing contraindicated analysis on any medications prescribed to the registered patient, transferring prescribed medication information to the system, the information associated with a medication schedule, and dispensing medication from the medical device to the registered patient upon graphical recognition of performed gestures.

### CROSS REFERENCE TO RELATED APPLICATIONS

This application claims the benefit of U.S. Provisional Application No. 61/756,352 filed on Jan. 24, 2013 which is hereby incorporated herein by reference.

### TECHNICAL FIELD

This disclosure relates to medication management, and more particularly to managing the delivery of medications to specific patients through biometric authentication, gesture recognition technology, photo and video capture (live feed with an observer and/or recorded) as well as breath analysis for the appropriate delivery and confirmation of medication ingestion.

### BACKGROUND

The statements in this section merely provide background information related to the present disclosure and may not constitute prior art.

Prescription drug abuse is a serious societal problem in the U.S. The problem is multi-faceted: (1) individuals may take more than what is prescribed or take someone else's medications (addiction); (2) individuals may claim pain to a medical professional in order to obtain medications which they resell to make a profit (diversion); and (3) overdose deaths have become one of the leading cause of injury and death.

In some cases, in order to ensure that patients are taking the agreed upon pain medications, urine drug testing (UDT) is required. In a UDT, medical professionals look for: (1) the presence of prescribed medications in the urine as evidence of their use; and (2) the presence of non-prescribed medications and illicit drugs. UDT testing is problematic, inconvenient, and can be inaccurate. UDT is expensive, at approximately $20 per test, and over the course of a treatment plan can cost hundreds of dollars to the patient and the health insurance company. Nationally, the cost of UDT is in the billions of dollars given test costs and frequency of testing.

UDT are particularly problematic as laboratory error and test insensitivity can result in misleading data. Variations in absorption and distribution between patients, changes in urine pH, bacterial contamination, mislabeling, dilution and concentrations factors associated with the consumption of fluid etc. may all result in misdiagnosis and inaccurate conclusions. For specific drug detection, individuals have found ways to circumvent the testing such as by masking or use of a diuretic substance. In some cases, cut-off levels do not monitor at a level of 0 ng/mL so a negative reading does not mean that the substance is not present.

UDT testing is further disadvantaged by its inherent inability to determine if the patient is taking the prescribed dose. The screening and subsequent confirmation can only indicate the presence of a substance. For example, patients may be taking only some of their prescribed pain medication, even a couple of pills just to pass the urine drug test. Because there is no linear relationship between what is detected in the urine and how much drug was actually ingested, as long as the drug shows up in their urine, the patient is going to appear compliant. For example, patients may be taking all their medications at one time during the day instead of twice daily and thereby not getting the full benefit of the medicine as intended by the physician. Hence, the UDT screening and subsequent confirmation cannot indicate if the patient is taking the medications as directed by the physician or other medical professional.

Therefore, it would be advantageous to directly monitor or confirm a patient's use of prescribed medication without use of inferential information derived from UDT testing. It is particularly advantageous to monitor compliance with prescription directions having dosages of controlled substances such as those identified by the National Alliance for Model State Drug Laws (NAMSDL).

### SUMMARY

Method, system, and apparatus are disclosed for managing medication delivery. The method includes registering a plurality of patients with a system, associating a registered patient with personal biometric data, recording a plurality of patient tasks for subsequent recognition of task-events, associating the registered patient with an identifiable medical device, performing contraindicated analysis on any medications prescribed to the registered patient, transferring prescribed medication information to the system, the information associated with a medication schedule, and dispensing medication from the medical device to the registered patient upon graphical recognition of performed gestures, and/or confirmation of medication ingestion through live video or video recording and/or through analysis of patient breath on ingestion of the medication coated with a substance that is detectable on contact with stomach contents.

Certain embodiments of the invention include a feature of reducing or discouraging misuse of the medication by the patient or others, with the aspiration that the medication is being taken as prescribed.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows an exemplary medication monitoring system, in accordance with the present disclosure;

FIGS. 2 and 3 show an exemplary embodiment of the medical device, in accordance with the present disclosure;

FIG. 4 shows an exemplary medication, in accordance with the present disclosure;

FIG. 5 is a flow chart illustrating an exemplary process for managing medication dispensing using the system, in accordance with the present disclosure; and

FIG. 6 is a flow chart illustrating an exemplary process for operating the medical device communicatively connected within the system, in accordance with the present disclosure.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

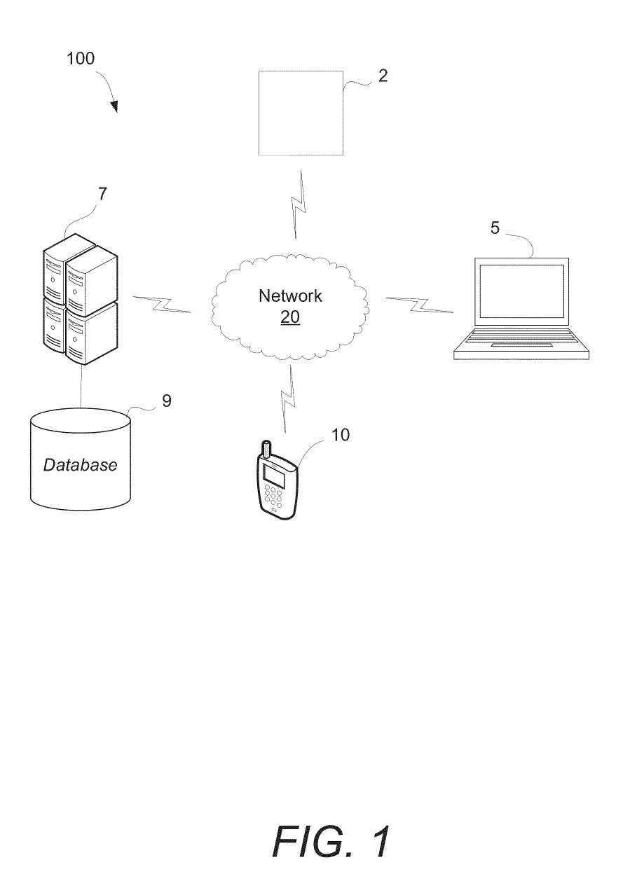

Referring now to the drawings, wherein the depictions are for the purpose of illustrating certain exemplary embodiments only and not for the purpose of limiting the same, FIG. 1 schematically shows an exemplary medication monitoring system 100 that may help implement the methodologies of the present disclosure. The system 100 includes a medical device 2, a server system 7, and a network 20. The system may further include any number of computing devices 5 and/or a mobile devices 10. As shown in FIG. 1, the computing device 5 may be directly communicatively connected to the mobile device 10 via the network 20 and/or directly communicatively connected to the mobile device 10. The server system 7 may be directly communicatively connected to the computing device 5 and the mobile device 10 via the network 20. The mobile device 10 may be physically connected to the network 20 or the computing device 5 during selected periods of operation without departing from the teachings herein. Components of the system 100 are shown in FIG. 1 as single elements. Such illustration is for ease of description and it should be recognized that the system 100 may include multiple additional mobile and computing devices.

The network 20 may be any suitable series of points or nodes interconnected by communication paths. The network 20 may be interconnected with other networks and contain sub networks network such as, for example, a publicly accessible distributed network like the Internet or other telecommunications networks (e.g., intranets, virtual nets, overlay networks and the like). The network 20 may facilitates the exchange of data between and among the mobile device 10, the computing device 5, and the server system 7 although in various embodiments the mobile device 10 may be directly connected to the computing device 5.

The computing device 5 and the server system 7 may each be: various embodiments of a computer including high-speed microcomputers, minicomputers, mainframes, and/or data storage devices. The server system 7 preferably executes database functions including storing and maintaining a database 9 and processes requests from the mobile device 10 and the computing device 5 to extract data from, or update, a database as described herein below. The server 7 may additionally provide processing functions for the mobile device 10 and the computing device 5 as will become apparent to those skilled in the art upon a careful reading of the teachings herein.

In addition, the mobile device 10 may include one or more applications that the user may operate. Operation may include downloading, installing, turning on, unlocking, activating, or otherwise using the application. The application may comprise at least one of an algorithm, software, computer code, and/or the like, for example, mobile application software. In the alternative, the application may be a website accessible through the world wide web.

The database 9 is preferably contained within one or more storage mediums, which may be virtually configured. The database is preferably secure and encrypted for selective, authorized access and configured to store, access, and modify information, and is preferably configured to store, access, and modify structured or unstructured data including, for example, relational data, tabular data, audio/video data, and graphical data.

In one embodiment, the database 9 includes data pertaining to: patient name, DOB, sex, gender, and patient unique ID among other identifiers. Patient's biometrics, such as fingerprints, facial recognition, iris/retina scans and voice recognition, motion/gesture recognition, linked to patient name and unique ID may be included. For each patient and each patient's prescription, the database 9 preferably includes medication details, such as name of controlled substance, dose, duration, number of refills. Additional details as programmed such as dose reminder alerts, health history, emergency contact, caregiver info, etc. may be included. Information within the database may be indexed by prescriber's unique ID, name or contact information, prescribing medical professional or any predetermined category-type. In one embodiment, search functionality enables a medical professional to view, access, and/or modify information within the database 9 upon proper authentication and adherence to predetermine protocols.

The server 7 may be communicatively linked to any national/statewide PDMP/PMIX and configured to exchange information bi-directionally. In one embodiment, the server 7 is linked to participating pharmacies and doctor's offices to share information bi-directionally.

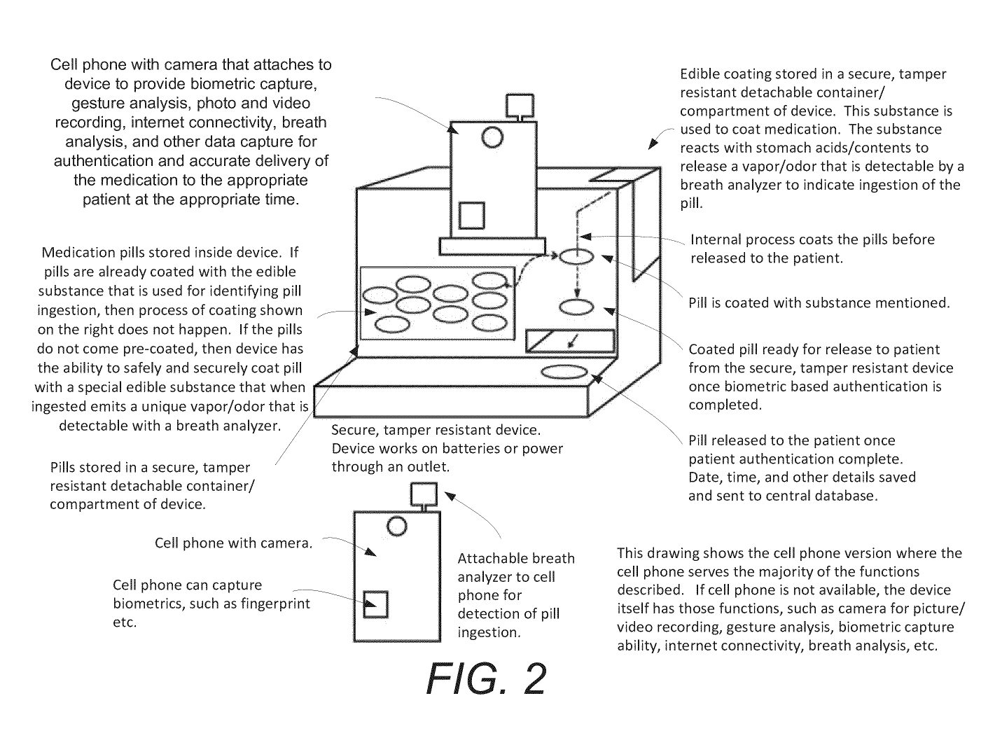

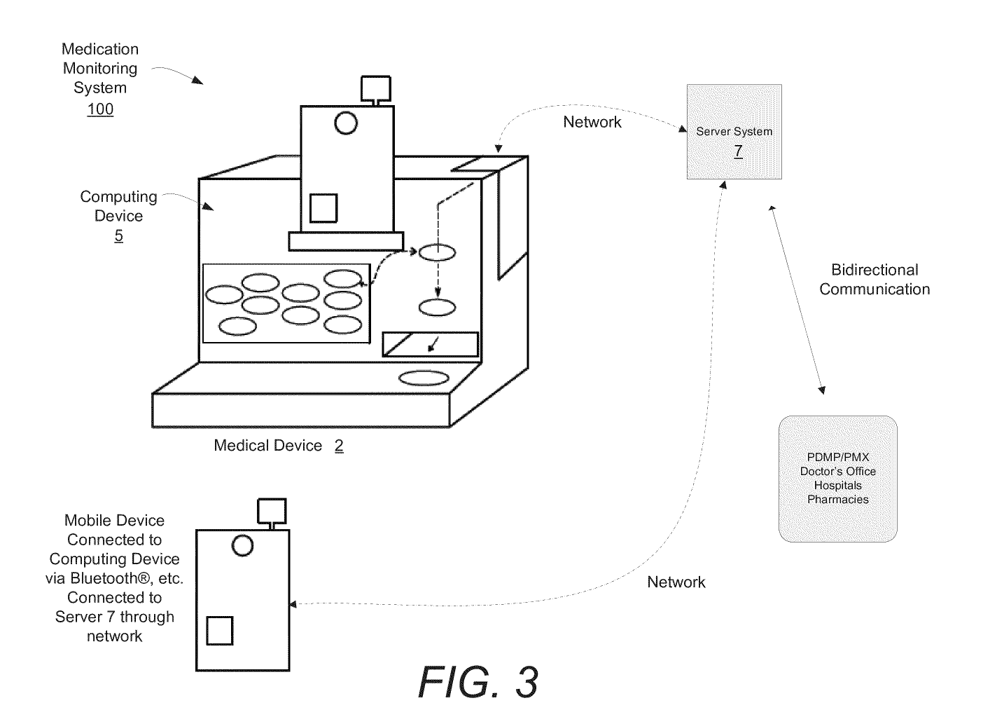

FIGS. 2 and 3 show an exemplary embodiment of the medical device 2. The medical device 2 includes a processor and non-transitory computer readable memory that stores various program code executable by the processor, i.e., software. The software is configured to process video stream data captured by a camera or CCD device, tracking locations of markers (i.e., visual tracking fiducials) at tips of a user's fingers using computer-vision techniques and algorithms, software programs configured to recognize the user's freehand gestures and postures, optical systems that track fingers with infrared LEDs and the cameras, and 3-D motion sensing techniques.

In one embodiment, the medical device 2 is configured to read identifiers affixed to medication. In this way, the device 2 reads the medication while the patient is taking the medication, thereby confirming consumption. In one embodiment, the identifiers are utilized in conjunction with visual data to determine consumption probabilities.

In one embodiment, the medical device 2 is configured to store and dispense medication and may include a tamper resistant supply. The medical device 2 can involves a regularly available medication storage container (RMSC) as obtained at the pharmacy or a more advanced one that may be in the marketplace. Embodiments of the medical device 2 contemplate one or more pill storage areas or cartridge attachment areas to serve patients with one or more drug prescriptions. Electronic components of the medical device 2 may be provided not for storage and delivery of medication, but for monitoring either through a standalone device, or the use of mobile device or computer, as described herein below.

A standalone RMSC (e.g., RMSC-S) device consists of a regularly available medication container as provided at a pharmacy and a standalone medical device 2 that has electronic circuits, including buttons, displays/screen, speakers, clock, microphone (including for use in voice recognition), camera (for transferring live feeds, recording video and iris/retina scans and facial recognition, motion recognition etc.), hard drive, usb/other access, wired or wireless intranet or internet access, fingerprint scanner, removable memory stick, power source, battery, and other typical components required to implement the algorithms and functions herein described.

In one embodiment, the camera (fixed or movable on its axis) has iris/retina detection functionality and facial recognition ability. Additionally, the medical device 2 may be configured to selectively, or in accordance with a predetermined algorithm, take a picture, sense and recognize motion, provide a live or recorded feed through the network 20. In one embodiment, multiple additional cameras are included, each having a predetermined purpose.

The medical device 2 is configured to recognizes movement, gestures etc. of picking up a pill from the device, putting it in the mouth and swallowing, etc., through such things as the camera, advanced software, and/or infrared LEDs.

In an embodiment, the computing device 5 or mobile device 10 may be utilized in conjunction with the medical device 2. The medical device 2 includes a conventional medication storage container. The mobile device 10 and/or the computing device 5 include executable instructions, i.e., software programs (e.g. an App) and other hardware (e.g. camera, and/or infrared LEDs, etc.) that enables it to do all the functions described hereinabove (can be attached externally if needed), such as provide facial recognition, iris/retina scan, fingerprint scan, sense motion, capture and validate certain specific motions. For example, recognize movement sequences, gestures of picking up a pill, putting it in the mouth and swallowing, etc.

The medical device 2 may be communicatively connected to the database 9 through the network 20. Captured video or a live feed may originate through short-wavelength transmissions. In one embodiment, the medical device includes a mobile device holder for placing the mobile device so a camera of the mobile device is situated at a particular angle for consistent reading and visualization. The holder may also, in one embodiment, include a camera, infrared LEDs and other technology for motion sensing, if not already available through the mobile device.

In one embodiment, the medical device includes a display. The display may have a clock. In one embodiment the medical device includes a microphone that may be used for voice recognition functions.

The medical device 2, in one embodiment, has a compartment configured to store medications either directly or in a tamper resistant cartridge which is placed into the tamper resistant device. Medications can be destroyed or otherwise made unusable in the device 2 if an attempt to tamper is detected. In one embodiment, upon tampering detection, the device 2 crushes the medication and mixes it with an indigestible material such that ingestion of the medication is unappetizing such as through a undesirable odor emanating from the destroyed medication.

In one embodiment, the medical device 2 is communicatively connected to a mobile device 10 or computing device 5 in order to utilize functions therein, e.g., built in camera, microphone, and display screen. The medical device 2 may then be controlled via software executed on the mobile device 10 or computing device 5 to perform the functions described herein.

In operation, medication may be dispensed based upon user authentication data such as facial recognition, password, and biometric data such as a fingerprint(s), voice-based information, or eye scan. If biometrics match, only the appropriate dose (e.g. one pill or two pills, etc.) of the medication is delivered out of the device for the patient to ingest based on a predetermined, prescription regime (which has been programmed into the device or is transferred from the server 7 through the network 20. The remaining supply of medication remains within the device inaccessible until the next dose is due and proper authentication supplied.

Authentication information may be supplied initially in a medical setting such as at a physician's office or pharmacy, administered or directed by a medical professional or remotely through the internet, in one embodiment. In one embodiment, biometrics are obtained and linked to the patient's name and unique ID as well as what the doctor has prescribed. The information may then be programmed into the medical device 2 and/or stored in the database 9. It is contemplated herein that a caregiver's information may be associated with access permissions into the medical device, as well.

Gestures and physical body motion sequences may be recorded for configuration of event recognition and detection. For example a patient's action of picking up medication from the medical device 2. An ingesting action may also be recorded and processed. Camera and visual devices, whether directly attached to the medical device 2 or utilized through a mobile device 10 or computing device 5 may provide a live feed to, for example, a remote nurse or other qualified staff so they are able to visually confirm the patient has ingested the appropriate medication. In one embodiment, the system 100 is configured to allow the remote staff to communicate with the patient, take notes, and recorded patient-based data to the database 9.

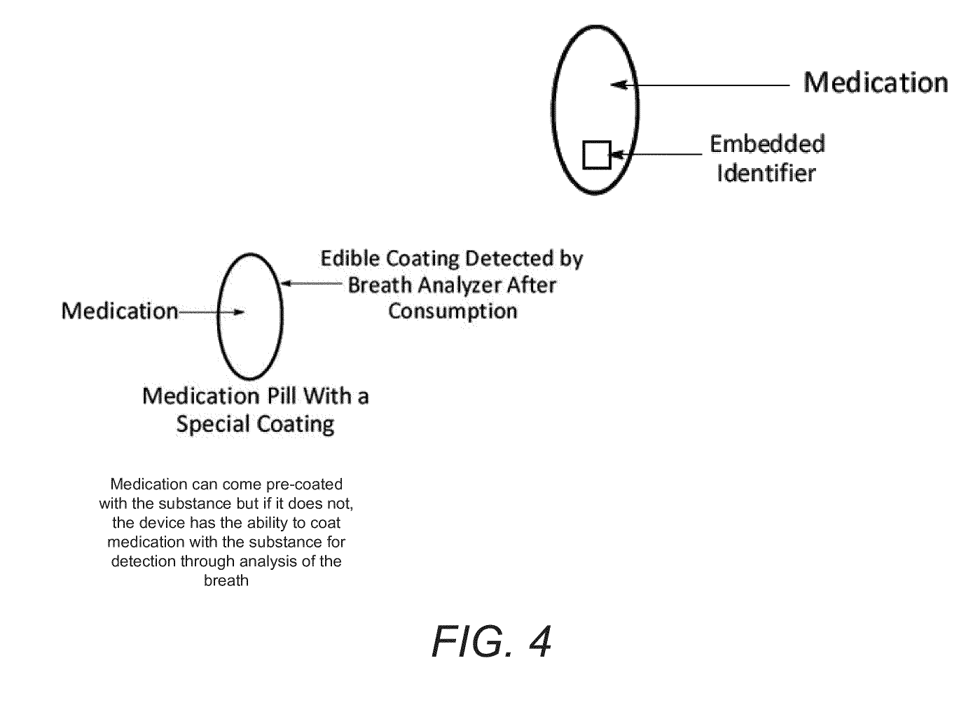

FIG. 4 shows an exemplary medication having an embedded identifier. In operation, the medical device 2 reads the identifier and determines whether an indigestion event has occurred based upon data correlatable to location of the pill and body motion analysis. Medications may be stored either in a regular container for the basic version or directly in the device or in a tamper resistant cartridge that is filled by a pharmacist based on the prescription for the advanced device. In one embodiment, a tamper resistant medication container may utilize an identifier that may be contained in a microchip, a radio frequency identification device (RFID), a smart card or a SIM card, a magnetic strip or a barcode etc with all the above mentioned information to communicatively send medication dispensing information to the medical device 2, e.g., schedule and quantity.

When the cartridge or medicine container is placed into the medical device 2 the cartridge may transmit information to the medical device 2. For example, correct matching of the prescription to the patient may be confirmed to ensure that the patient received the correct medicine. Drug dosages and scheduling information may also be transferred along with security settings, e.g., what to do if a dosage is missed.

Notification and alarm functionality may be provided in the system 100 to alert medical professionals, authorities or administrative staff if tampering of a medical device 2 is detected by the system 100. Records may be stored associated with a patient for tracking various data, dispensing history, and various metrics associated with use of the medical device 2. For example, quantity remaining in the cartridge (e.g. number of pills), dispensed quantity.

In one embodiment, the system 100 has access to all controlled substances (or other medications) the patient is taking so is able to provide appropriate alerts if the patient is on multiple such medications or determines the patient is at risk. Unlike traditional methods, the system 100 may be continually updating for contraindicated medicine combination and may access risk dynamically, and thereafter alert the patient. The system 100 may be programmed with other patient health history, e.g. allergies, medical history, etc., as well as other details in order to record or provide other services that are of benefit to the patient and the healthcare system. The system 100 may be configured to record all the above mentioned information and more and is able to provide the physician and/or other healthcare providers with both details and summary report of the doctor's prescription habits and the patient's compliance in ingesting the appropriate medication, amount, time, date, for example.

The medical device 2 may be configured to communicate with the server 7 in real time or on a predetermined frequency basis, providing up to date information to physician's office and pharmacy, as desired.

In one embodiment, the medical device 2 or associated software application through the mobile device 10 or computing device 5 may be configured to allow for the patient to contact a live nurse or other staff for help with the device at any time, via text, audio, video or email, as preferred by the patient.

All data and other communication is preferably encrypted, secure and compliant with governmental law, regulations and rules such as promulgated by HIPAA and HITECH.

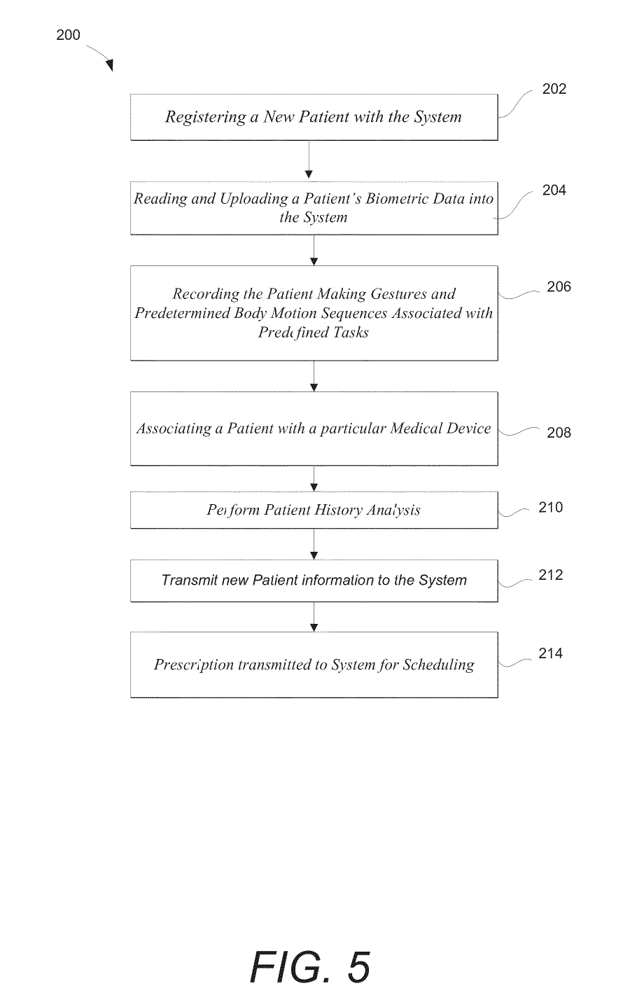

FIG. 5 is a flow chart illustrating an exemplary process 200 for managing medication dispensing using the system 100. While the system 100 may be used for any prescription having drug dosages, the medical device 2 is particularly useful when prescribing controlled substances to a patient such as an opiate-based drug. As FIG. 5 shows, at step 202 the system 100 registers a new patient with the system 100. The system 100 receives patient profile-based information and any other medical information associated with the patient and the patient's medical history, e.g., current medications and dosage plans, allergies, alerts, etc., for storage in the database 9. Registering the new patient may further include generating a unique patient identification number. It is contemplated that a medical professional may upload the information from a workstation computer such as the computing device 5 to the server 7 and database 9, however the information may be locally stored and utilized with a patient's medical device 2 consistent with the teachings herein.

At step 204, patent's biometric data are read and uploaded into the system 100. As described hereinabove, the patient's biometrics obtained may include iris/retina scan, fingerprint, photograph/facial recognition, video, motion sensing and recognition, and/or voice recognition.

At step 206, video is recorded of the patient making gestures and body motion sequencing for separate tasks for calibrating gesture and event recognition techniques. Recorded sequences can include: picking up a medication from the dispenser, placing it into the mouth, swallowing it and showing an empty mouth. In this way a staff operator or imaging recognition sequence may determine that the medication is not hidden in the mouth. In one embodiment, the gesture and event recognition may be used in conjunction with the medication identifiers. As described hereinabove, bounced radio transmissions from micro antennas embedded on the pills may be used to determine location of the pill with respect to the medical device 2 or at least distance from the medical device 2. Distance combined with event recognition may increase probabilistic inferences available to the system 100, thereby increasing efficiency and accurate recognition of events.

This may also involve advanced technology that includes a medication with some kind of an identifier that can be read by the device to confirm delivery from the device, movement into the mouth and ingestion

At step 208, a patient is associated with a particular medical device 2. While the patient is indexed in the database with a unique identifier, a medical device 2 associated with the patient preferably is associated with a unique identifier as well.

At step 210, the system 100 can perform contraindicated analysis on medications prescribed to a patient. As one skilled in the art will readily recognize, this step may occur irrespective of the sequence illustrated and described herein. For example, step 210 may be separately executed on a periodic schedule or selectively, or upon occurrence of an event such as the uploading of new contraindicated medicine. Upon an alert of contraindicated prescriptions, the physician can either continue with the new prescription, reduce dose or make any other appropriate decision, for example letting the patient know that no new narcotic will be prescribed. The system 100 may additional be configured to detect that a patient is not on multiple similar medication or doctor shopping.

At step 212 a medical professional can enter in a new medication for the patient. The medication may be associated with a schedule, e.g., twice daily for a week, associated with a refill policy, and associated with instructions, e.g., with food. The information may be sent to a pharmacy or third-party entity for delivery of the medication.

At step 214 the medication and scheduling information is uploaded to the database 9. Upon proper electronic logging of the medication, the medication may be physically delivered to the patient, coupled to the medical device 2, or delivery via a tamper resistant container for subsequent coupling to the medical device 2.

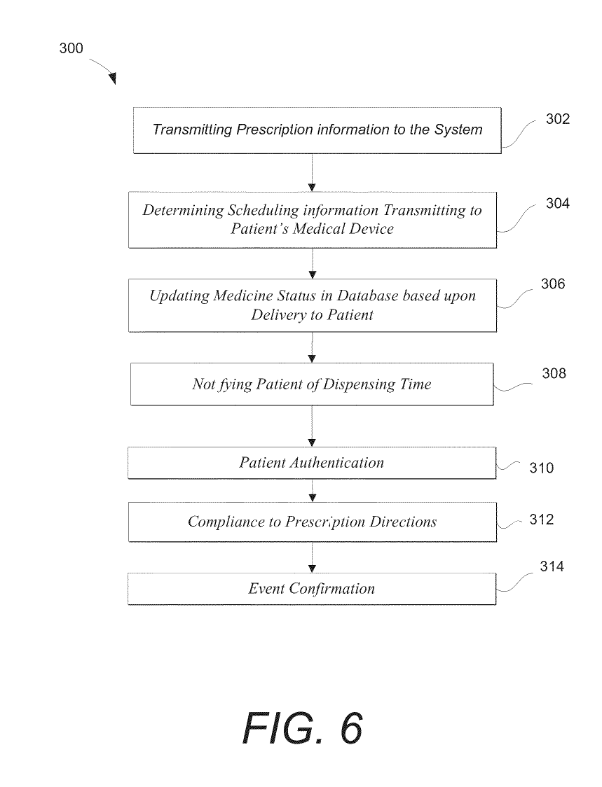

FIG. 6 is a flow chart illustrating an exemplary process 300 for operating the medical device 2 communicatively connected within the system 100. The process 300 begins at step 302 wherein a prescription is entered into the database 9 by a medical professional and associated with a patient. At step 304, scheduling and medical information associated with the prescription is communicated to the patient's medical device 2 or associated to the patient within the database 9 for retrieval. Step 304 may be initiated via the insertion of the medicine cartridge into the medical device 2 or selectively by the medical professional. At step 306, the medicine associated with the prescription is delivered to the patient by a pharmacist or other medical professional. The delivery may cause an update in patient status and/or initiate the scheduling of the prescription within the system 100. In one embodiment, the delivery may be executed by scanning via a barcode, magnetic strip, RFID, or microchip having medicine information including an identifier.

At step 308, once deployed in a dispensing environment for use, the medical device 2 may send an electronic notification or otherwise visually or audibly alert the patient of a dispensing time. To initiate dispensing, at step 310 the patient must appear in a field-of-view of a camera of the medical device 2 or communicatively linked to the device 2 via a connected mobile device 10 or computing device 5 as described herein above. The device 2 authenticates the user via any number of methods including biometric data, visual imaging recognition, user inputted password, or voice recognition.

For certain specific drug prescriptions, the patient must validate compliance with the prescription orders. Hence, at step 312 the patient can record ingestion or validate compliance with specific prescription requirements, selectively in one embodiment or automatically in another. The device 2 may provide instructions to the patient for following compliance directions. Instruction may include, for example, such things as making sure the patient is in front of a clear wall, has the medication container in front of them, possibly uses a barcode or other identifiable indicator on medication container. The device 2 may provide detailed instructions to the patient for medication ingestion, observing the patient opening the medication container, taking a pill, placing it in their mouth, ingesting it and showing an empty mouth. Observation can be a live feed with to a medical professional to confirm ingesting of the particular medication in real-time, or it can be recorded for later confirmation by staff to then credit the patient's account as having been compliant with the appropriate dose.

In one embodiment, the device 2 utilizes imaging identification techniques and motion recognition processes to record and/or confirm an event such as ingestion by an identified patient 314. Upon confirming ingestion of a dispensed dose, the system 100 credits the patient's account as having been compliant with the medication at that particular time. The system 100 may be configured for selective recordings or used only for audits or confirmation as needed.

The patient's compliance log is preferably automatically transmitted to the database 9 through the network 20 or subsequently brought to the doctor's office using the device 2 at patient visit, on the mobile device 10 or otherwise transferred for subsequent uploading to the database 9 and for prescription compliance. The system enables a medical professional to selectively, or through automated reporting monitor a patient's account for compliance with prescription.

As described herein above, the system 100 preferably has bidirectional communication with PDMP/PMIX as well as other pharmacies and doctors' offices to help monitor and manage patient compliance. Operation of the system is further advantaged by deterring doctor shopping and reducing prescription errors through built in monitoring routines and reporting checks.

The medical device 2 can additionally be utilized to gather other information, such as a time and date stamp, rating of pain at time of medication ingestion, etc. Similarly, it can be used to educate patients to maximize a treatment plan. Widespread or universal use of the system 100 can maximize the best utilization of the system for complete monitoring of controlled and uncontrolled substances. As one skilled in the art will recognize, the system 100 can be used alone or in conjunction with current drug monitoring methodologies, such as POCT and quantitative drug confirmation.

Referring back to FIG. 4 showing an exemplary pill having an edible, biodegradable coating, the coating is configured to release an identifiable vapor or odor after reacting with stomach acid or otherwise becoming dissolved within the digestive system of a patient. In one exemplary embodiment, for example, the coating is made up of a safe, ingestible, polymer or polysaccharide or volatile organic compound, or one that breaks down into a metabolite that is detectable, etc. These vapors are detectable in the breath. Therefore, in one embodiment, in order to further ensure compliance with prescription directions, the device 2 is further affixed with a vapor or chemical detector configured to detect the identifiable reactant. In one embodiment, the chemical detector is affixed or formed of the medical device 2. In one embodiment the chemical detector is communicatively and operatively connected to the mobile device 10 for control and operation thereof. In one embodiment, for example the chemical reaction of the pill with the digestive system may be detected or inferred from readings of an infrared light detection device, spectroscopy techniques, chromatography techniques. The odor or chemical reaction device can be handheld, independent of main device, or attachable to a cell phone etc.

In operation, the identifiable odor/vapor is only detectable for a limited time after ingestion and is specific for certain biomarkers. Similar to above, the detection information may be communicated to the system for analysis, storage, and compliance monitoring. As shown in Fig XX, if the medication does not come in a pre-coated format for the detection of ingestion through the breath, the device is capable of coating the medication with the edible substance within it, through a safe, tamper resistant process such that the medication when dispensed is coated to be identified through the process mentioned.

This part, whereby the ingestion of the pill is confirmed through an analysis of the breath, may be independent of previous components. Similarly, different levels of the above process/requirements can be placed on patients based on patient predetermined risk profile. For example, patients who are considered non-compliant or at higher risk of illegally selling medications, etc., have a higher level of scrutiny by requiring them to complete most/all steps while as those who are compliant/low risk only have to take certain steps.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method for managing medication delivery, the method comprising:
registering a plurality of patients with a system;
associating a registered patient with personal biometric data;
recording a plurality of patient tasks for subsequent recognition of task-events;
associating the registered patient with an identifiable medical device;
performing contraindicated analysis on any medications prescribed to the registered patient;
transferring prescribed medication information to the system, the information associated with a medication schedule; and
dispensing medication from the medical device to the registered patient upon graphical recognition of performed gestures.

2. The method of claim 1, further comprising:
transferring prescription compliance rules associated with a prescribed medication;
communicating a request to the patient to perform a gesture; and
performing gesture recognition analysis to determine compliance with the prescription compliance rules.

3. The method of claim 2, wherein the gesture comprises opening a mouth in a field-of-view of a camera of the medical device.

4. The method of claim 2, wherein the gesture recognition analysis is performed using data transmitted from one of a camera, radio waves.

5. The method of claim 2, wherein the gesture recognition analysis is performed, in part, based upon information transmitted from a dispensed pill.

6. The method of claim 2, further comprising a tamper resistant device configured to contain pills and coat these pills with an edible substance that can be detected in the breath on ingestion.

7. The method of claim 2, wherein if a pill is not coated with the substance detectable in the breath on ingestion, coats the pill in a tamper resistant method and dispenses the pill to the patient.

8. The method of claim 2, further comprising:
analyzing a patient's breath using a breath analyzer, subsequent to an individual ingesting a pill having an exterior coating configured for post digestion detection.
